(19) United States
(12) Patent Application Publication
(10) Pub. No.: US 2023/0160087 A1
(43) Pub. Date: May 25, 2023

(54) METHOD OF PRODUCING A GRAPHENE FILM

(71) Applicant: Elecjet Corp, Missouri City, TX (US)

(72) Inventors: Samuel Gong, Brentwood, TN (US); Lin Weijia, Shenzhen (CN)

(21) Appl. No.: 17/990,706

(22) Filed: Nov. 20, 2022

Related U.S. Application Data
(60) Provisional application No. 63/282,178, filed on Nov. 23, 2021.

(51) Int. Cl. C25D 13/02; C01B 32/225; C01B 32/19; C25D 13/12; C25D 13/22; H01M 4/139; H01M 4/04; H01M 4/62

(52) U.S. Cl. CPC C25D 13/02; C01B 32/225; C01B 32/19; C25D 13/12; C25D 13/22; H01M 4/139; H01M 4/0457; H01M 4/625; H01M 4/0471; C01B 2204/22; H01M 2004/027

(57) ABSTRACT

A graphene composite film is produced for application to the anode of a battery. A graphene dispersion is peeled off of a graphite solvent mixture ultrasonically. The graphene material is then mixed with organic amine salt to be charged. Electrophoretic deposition is used to turn the graphene into a film. The film is then passed through a heat treatment to remove the organic amine salt. The resulting film is a highly conductive graphene film with a two-dimensional structure.

### RELATIONSHIP TO OTHER APPLICATIONS

This application claims the benefit of U.S. provisional patent application Ser. No. 63/282,178 filed Nov. 23, 2021 to the same inventors.

### FIELD OF THE INVENTION

The present invention generally relates to graphene film production and, more particularly, to a method of producing a graphene film on an anode.

### BACKGROUND OF THE INVENTION

Metal oxides are conventionally used in battery manufacturing. However, such materials have relatively low conductivity and tensile strength which often results in the battery quickly losing the ability to fully charge after a given number of cycles as well as not being able to handle the size fluctuations when the battery heats up and cools off. Graphene is a material having the very significant electricity and heat conductivity properties. Additionally, graphene is also over one hundred times stronger than steel making it suitable for physically demanding applications such as the expansion and compression of a battery as it gets hot and then cools.

Graphene is conventionally produced using micro mechanical exfoliation, chemical vapor deposition, graphite oxide reduction and organic synthesis. These methods, however, have many limitations such as being hard to produce high quality graphene, extremely high costs and oxidation or defects. Graphene has largely been too cost-prohibitive to use effectively in batteries.

### SUMMARY OF THE INVENTION

A graphene composite film is produced for application to an anode for a battery. A graphene dispersion is peeled off of a graphite solvent ultrasonically. The graphene material is them mixed with organic amine salt to be charged. Electrophoretic deposition is used to turn the graphene into a film. The film is then passed through a heat treatment to remove the organic amine salt. The resulting film is a highly conductive graphene film with a two-dimensional structure.

A significant advantage provided by the present invention is that it is a low-cost process. Another advantage provided by the present invention is that it is easy to scale.

### DESCRIPTION OF THE FIGURES OF THE DRAWINGS

The present invention will hereinafter be described in conjunction with the following drawing figures, wherein like numerals denote like elements, and

FIG. 1 is a process diagram illustrating an exemplary embodiment of the present invention, according to a preferred embodiment of the present invention;

FIG. 2 is a process diagram illustrating exemplary details of step one of the exemplary process of FIG. 1 of the present invention, according to a preferred embodiment of the present invention;

FIG. 3 is a process diagram illustrating exemplary details of step two of the exemplary process of FIG. 1 of the present invention, according to a preferred embodiment of the present invention;

FIG. 4 is a process diagram illustrating exemplary details of step three of the exemplary process of FIG. 1 of the present invention, according to a preferred embodiment of the present invention; and

FIG. 5 is a process diagram illustrating exemplary details of step four of the exemplary process of FIG. 1 of the present invention, according to a preferred embodiment of the present invention.

### DETAILED DESCRIPTION OF THE INVENTION

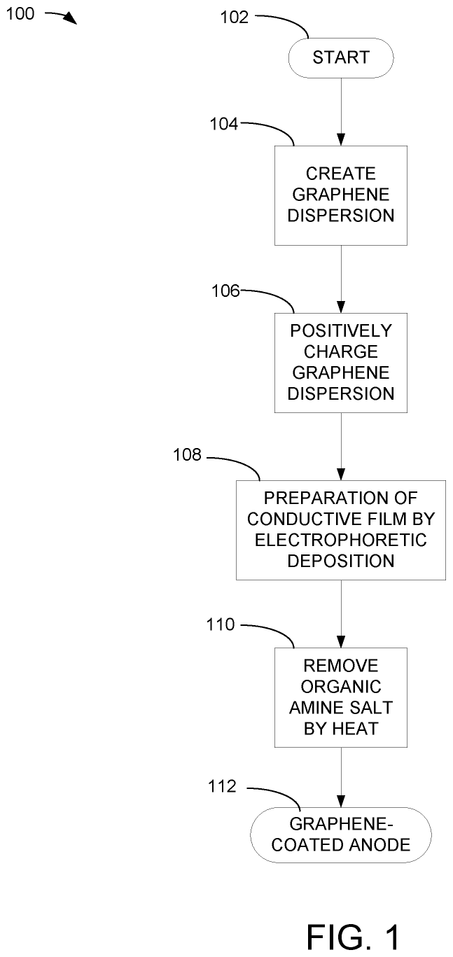

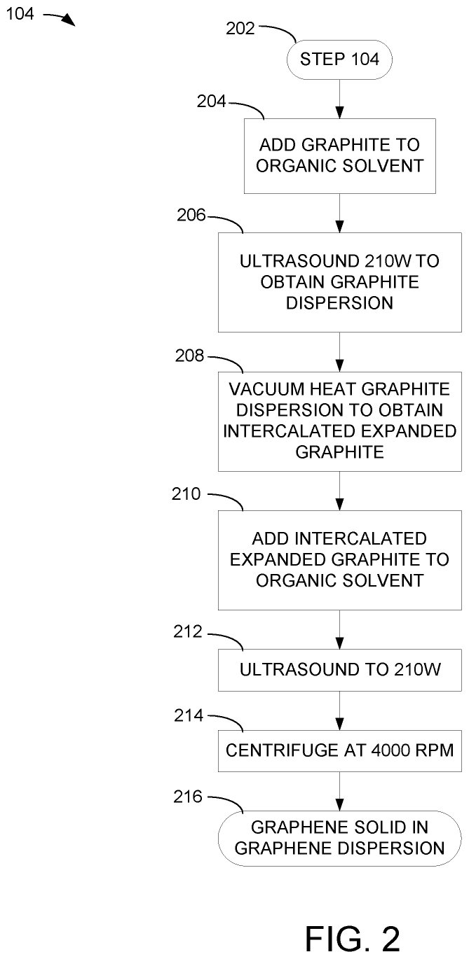

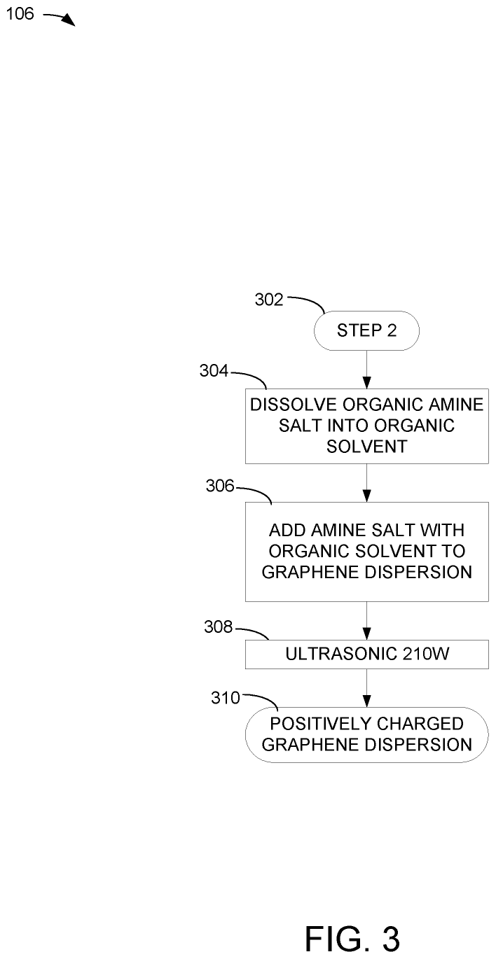

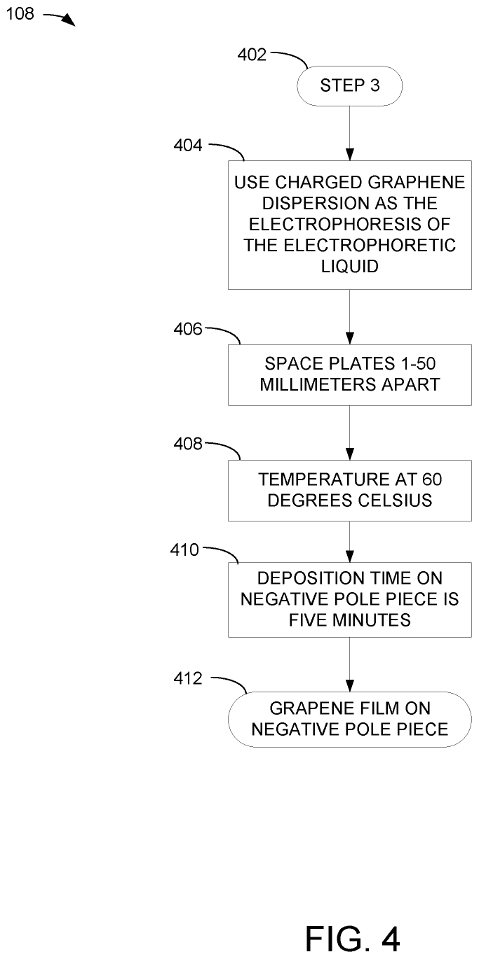

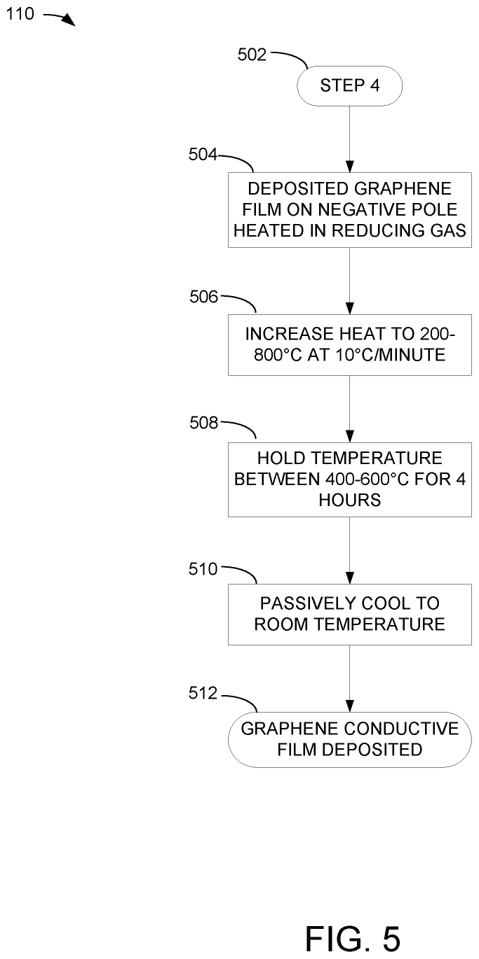

FIG. 1 is a process diagram illustrating an exemplary embodiment of the process 100 for making and adhering a graphene film, according to a preferred embodiment of the present invention. In step 102, equipment for the process is made ready, including an ultrasonic tank, a centrifuge, a vacuum furnace, and associated containers. In step 104, a graphene dispersion is created, as will be described in more detail in regard to FIG. 2. In step 106, the graphene dispersion is positively charged, as will be described in more detail in regard to FIG. 3. In step 108, a conductive film is prepared by electrophoretic deposition, as will be described in more detail in regard to FIG. 4. In step 110, the organic amine salt used to charge the graphene dispersion in step 106 is removed, as will be described in more detail in regard to FIG. 5. Step 112 is to collect the graphene-coated anode or anodes as the final product of the process.

FIG. 2 is a process diagram illustrating exemplary details of step 104 of the exemplary process 100 of FIG. 1 of the present invention, according to a preferred embodiment of the present invention. Step 202 begins the step 104 of creating a graphene dispersion. In step 204, graphite is added to an organic solvent in the ratio of graphite to organic solvent of 1 g:10 ml. The organic solvent is preferably NMP(1-methyl-2-pyrrolidone). In particular embodiments, the organic solvent may be, for non-limiting examples, acetone, methanol, or ethanol. The graphite and organic solvent mixture is placed in an ultrasonic chamber operating at 210 Watts for a period of between thirty minutes to one-hundred-twenty minutes to obtain a graphite dispersion. In step 206, the graphite dispersion is placed in a vacuum furnace heated at a rate of ten degrees Celsius per minute under the protection of nitrogen. In step 208, the graphite dispersion is heated for one to four hours at a temperature ranging from four hundred degrees Celsius to about eight hundred degrees Celsius and then passively cooled to room temperature to obtain solvent-intercalated expanded graphite. In step 210, the solvent-intercalated expanded graphite is added to additional organic solvent to achieve a solid content of one gram of solvent-intercalated expanded graphite per liter of organic solvent. In step 212, the solution created in step 210 is subjected to ultrasonic energy at two hundred and ten Watts for a period in the range of one hour to ten hours. In step 214, the solution created in, step 212 is paced in a centrifuge and centrifuged at four thousand revolutions per minute for a period in the range of thirty minutes to one-hundred twenty minutes to obtain a graphene solid content in the graphene dispersion in the range of 0.01 grams of graphene per liter of organic solvent and 0.1 grams of graphene per liter of organic solvent. FIG. 3 is a process diagram illustrating exemplary details of step 106 of the exemplary process 100 of FIG. 1 of the present invention, according to a preferred embodiment of the present invention. The purpose of step 106 is to positively charge the graphene dispersion. In step 302, the process continues with the graphene dispersion produced in step 212. In step 304, organic amine salt is dissolved, into the organic solvent in a ratio of one gram per liter to create an amine salt solution. The organic amine salt used is, for non-limiting examples, aniline hydrochloride or benzidine dihydrochloride, which contain aromatic structural groups and negative ions of Cl⁻, NO3⁻, and SO4²⁻. In step 306, the amine salt solution is added to the graphene dispersion from step 212. In step 308, the solution created in step 306 is subjected to ultrasonic energy at two hundred and ten Watts for a period ranging from ten minutes to thirty minutes. In step 310, the result of step 308, a positively charged graphene dispersion, is collected.

FIG. 4 is a process diagram illustrating exemplary details of step 108 of the exemplary process 100 of FIG. 1 of the present invention, according to a preferred embodiment of the present invention. Step 402 begins the preparation of a conductive film by electrophoretic deposition. In step 404, The graphene dispersion obtained in step 310, above, is used as the electrophoresis of a electrophoretic liquid. In step 406, an electrical current is applied across the positive and negative plates for the electrophoresis. The plates are preferably spaced apart by a gap in the range of one millimeter to fifty millimeters and most preferably fifteen millimeters. In step 408, the temperature of the electrophoretic liquid is maintained at approximately sixty degrees Celsius. In step 410, a graphene film deposits on the negative pole piece, or anode, over approximately five minutes. In step 412, the negative pole piece with the graphene film coating it is collected.

FIG. 5 is a process diagram illustrating exemplary details of step 110 of the exemplary process 100 of FIG. 1 of the present invention, according to a preferred embodiment of the present invention. Step 502 begins the removal of organic amine salt by heat. In step 504, the graphene film deposited on the negative pole piece is heated in a reducing gas, such as nitrogen. In Step 506, the heat is increased at a rate of ten degrees Celsius per minute to a final temperature within the range of two hundred degrees Celsius and eight hundred degrees Celsius. In step 508, the temperature is maintained in a range between four hundred degrees Celsius and six hundred degrees Celsius for approximately four hours. In step 510, the graphene-coated negative pole piece is passively cooled to room temperature by simply turning off the heat. In step 512, the negative pole piece having the highly conductive graphene film deposited on the negative pole piece, is collected for use in making a battery.

The result of process 100 is a conductive graphene composite film that can be used in a variety of battery applications such as lithium polymer pouch to lithium ion cylindrical battery cells.

The process 100 may be used to apply graphene composite conductive film to an anode of a lithium polymer battery to increase power density and life cycles A single sheet, or several sheets, may be applied depending on application. When a battery charges, the battery may swell and then compress as it cools. This is a physically taxing, but increased conductivity reduces resistance and therefor heat and the attendant swelling of the battery.

Graphene resolves three key deficiencies in batteries: conductivity (heat generation), power density, and life cycles.

The following claims include some functional claiming and do not include any statements of intended purpose.

I claim:

1. A method of producing and depositing a graphene film on an anode, comprising the steps of:
a. creating a graphite dispersion;
b. electrostatically charging said graphene dispersion by addition of an organic amine salt;
c. applying a conductive graphene film to said anode by electrophoretic deposition; and
d. removing said organic amine salt from said deposited graphene film by application of heat.

2. The method of claim 1, wherein the step of creating a graphene dispersion comprises the steps of:
a. adding graphite to an organic solvent to create a graphite and organic solvent mixture;
b. applying first acoustic power at 210 Watts to said graphite and organic solvent mixture to create a graphite dispersion;
c. heating said graphite dispersion in a vacuum furnace and then passively cooling said graphite dispersion to obtain solvent-intercalated expanded graphite;
d. adding said solvent-intercalated expanded graphite to additional said organic solvent;
e. applying second ultrasonic power to said solvent-intercalated expanded graphite and said organic solvent mixture at 210 Watts;
f. centrifuging said solvent intercalated expanded graphite in said organic solvent at 4000 revolutions per minute to obtain graphene solid content in said graphene dispersion that comprises at least 0.01 grams of graphene per liter of said organic solvent.

3. The method of claim 2, wherein said graphite and organic solvent mixture comprises a ratio of one gram of said graphite per ten milliliters of said organic solvent.

4. The method of claim 2, wherein said first and second acoustic powers comprise 210 Watts for 30 minutes to 120 minutes, and one hour to ten hours, respectively.

5. The method of claim 2, wherein said vacuum furnace is heated at a rate of ten degrees Celsius per minute, under protection of a reducing gas, to obtain a temperature in the range of 400 to 800 degrees Celsius for a period of one hour to four hours.

6. The method of claim 2, wherein said graphene solid content in said graphene dispersion is not more than 0.1 grams of graphene solid content per liter.

7. The method of claim 2, wherein said solvent-intercalated expanded graphite added to said organic solvent creates a solid content of one gram of said solvent-intercalated expanded graphite per one liter of said organic solvent.

8. The method of claim 2, wherein the step of electrostatically charging said graphene dispersion by addition of said organic amine salt comprises the steps of:
a. dissolving said organic amine salt into said organic solvent;
b. adding said organic amine salt dissolved into said organic solvent into said graphene dispersion;
c. applying ultrasonic power at 210 Watts to said mixture of organic amine salt, said organic solvent, and said graphene dispersion to create a positively charged graphene dispersion.

9. The method of claim 8, wherein said ultrasonic power is applied for a period of between 10 minutes and 30 minutes, inclusive.

10. The method of claim 8, wherein the step of applying a conductive graphene film to said anode by electrophoretic deposition comprises the steps of:
a. using said charged graphene dispersion as the electrophoresis of the electrophoretic liquid;
b. placing at least one anode plate and at least one cathode plate in said electrophoretic liquid, parallel and spaced apart in the range of one millimeter to fifty millimeters;
c. applying current across said at least one anode plate and at least one cathode plate; and
d. maintaining the temperature of the electrophoretic liquid at approximately sixty degrees Celsius for five minutes to deposit said graphene film on said at least one anode plate.

11. The method of claim 10, wherein said spaced-apart distance comprises fifteen millimeters.

12. The method of claim 10, wherein the step of removing said organic amine salt from said deposited graphene film by application of heat comprises the steps of:
a. heating said graphene-film-deposited at least one anode plate in the presence of a reducing gas to a temperature in the range between two hundred degrees Celsius and eight hundred degrees Celsius at a rate of ten degrees Celsius per minute;
b. maintaining said heating temperature in the range of four hundred degrees Celsius and six hundred degrees Celsius for approximately four hours; and
c. passively cooling the resulting said graphene-film-deposited at least one anode plate to room temperature.

13. A method producing and depositing a graphene film on an anode comprising the steps of:
a. adding graphite to an organic solvent in the ratio of graphite to organic solvent of 1 gram per 10 milliliters;
b. applying ultrasonic energy at 210 Watts to said graphite and organic solvent mixture for a period between thirty minutes to one-hundred-twenty minutes to create a graphite dispersion;
c. heating said first graphite dispersion in a vacuum furnace, heated at a rate of ten degrees Celsius per minute under the protection of nitrogen and maintain heat in a range between four hundred degrees Celsius to eight hundred degrees Celsius for a period between one and four hours, to obtain solvent-intercalated expanded graphite;
d. adding said solvent-intercalated expanded graphite to said organic solvent again to prepare a mixture having a solid content of one gram of solvent-intercalated expanded graphite per liter of said organic solvent;
e. apply ultrasonic energy at 210 Watts for a period in the range of one hour to ten hour to said mixture having a solid content of one gram per liter gram of solvent-intercalated expanded graphite per liter of said organic solvent;
f. centrifuging said solvent-intercalated expanded graphite in said organic solvent at four thousand revolutions per minute for a period between thirty and 120 minutes to obtain graphene solid content in the graphene dispersion that is 0.01 to 0.1 grams of said graphene per liter of said organic solvent.

14. The method of claim 13, comprising the steps of:
a. dissolving said organic amine salt into said organic solvent to achieve a ratio of one gram of organic amine salt per liter of said organic solvent;
b. adding said organic amine salt dissolved into said organic solvent into said graphene dispersion;
c. applying ultrasonic energy at 210 Watts to said organic amine salt in said organic solvent and graphene dispersion mixture for a period between ten minutes and thirty minutes to create a positively charged graphene dispersion.

15. The method of claim 14, comprising the steps of:
a. using said positively charged graphene dispersion as the electrophoresis of an electrophoretic liquid;
b. placing at least one anode plate and at least one cathode plate in said electrophoretic liquid, parallel and spaced apart by fifteen millimeters;
c. applying current across said at least one anode plate and at least one cathode plate; and
d. maintaining the temperature of the electrophoretic liquid at approximately sixty degrees Celsius for five minutes to deposit said graphene film on said anode.

16. The method of claim 15, comprising the steps of:
a. heating said graphene-film-deposited anode in the presence of one of nitrogen and other reducing gas to a range between two hundred degrees Celsius and eight hundred degrees Celsius at a rate often degrees Celsius per minute;
b. maintaining a temperature in the range of four hundred degrees Celsius and six hundred degrees Celsius for approximately four hours; and
c. passively cooling said graphene-film-deposited anode to room temperature.

17. A method producing and depositing a graphene film on an anode comprising the steps of:
a. adding graphite to an organic solvent in the ratio of graphite to organic solvent of 1 gram of graphite per 10 milliliters of organic solvent, wherein said organic solvent is one of:
i. NMP(1-methyl-2-pyrrolidone);
ii. acetone;
iii. methanol; and
iv. ethanol;
b. applying ultrasonic energy at 210 Watts to said graphite and organic solvent mixture for a period between thirty minutes to one-hundred-twenty minutes to create a graphite dispersion;
c. heating said first graphite dispersion in a vacuum furnace, heated at a rate of ten degrees Celsius per minute under the protection of nitrogen and maintain heat in a range between four hundred degrees Celsius to eight hundred degrees Celsius for a period between one and four hours, to obtain solvent-intercalated expanded graphite;
d. adding said solvent-intercalated expanded graphite to said organic solvent again to prepare a mixture having a solid content of one gram of said solvent-intercalated expanded graphite per liter of said organic solvent;
e. applying ultrasonic energy at 210 Watts for a period in the range of one hour to ten hours to said mixture having a solid content of one gram of said solvent-intercalated expanded graphite per liter of said organic solvent;
f. centrifuging said mixture of solvent-intercalated expanded graphite in said organic solvent at four thousand revolutions per minute for a period between thirty minutes and 120 minutes to obtain graphene solid content in said graphene dispersion that is 0.01 to 0.1 grams of said graphene per liter of said organic solvent.

18. The method of claim 13, comprising the steps of:
a. dissolving an organic amine salt into said organic solvent to achieve a ratio of one gram of organic amine salt per liter of said organic solvent, wherein said organic amine salt comprises one of:
i. aniline hydrochloride; and
ii. benzidine dihydrochloride;
b. adding said organic amine salt dissolved into said organic solvent into said graphene dispersion;
c. applying ultrasonic energy at 210 Watts for a period between ten minutes and thirty minutes to said organic amine salt in said organic solvent and graphene dispersion mixture to create a positively charged graphene dispersion.

19. The method of claim 14, comprising the steps of:
a. using said positively charged graphene dispersion as the electrophoresis of an electrophoretic liquid;
b. placing at least one anode plate and at least one cathode plate in said electrophoretic liquid, parallel and spaced apart in by fifteen millimeters;
c. applying current across said at least one anode plate and at least one cathode plate; and
d. maintaining the temperature of the electrophoretic liquid at approximately sixty degrees Celsius for five minutes to deposit said graphene film on said at least one anode plate.

20. The method of claim 15, comprising the steps of:
a. heating said graphene-film-deposited anode plate in the presence of one of nitrogen and other reducing gas to a range between two hundred degrees Celsius and eight hundred degrees Celsius at a rate often degrees Celsius per minute;
b. maintaining said at least one graphene-film-deposited anode plate at a temperature in the range of four hundred degrees Celsius and six hundred degrees Celsius for approximately four hours; and
c. passively cooling said at least one graphene-film-deposited anode plate to room temperature.
